(19) United States
(12) Patent Application Publication
(10) Pub. No.: US 2004/0225953 A1
(43) Pub. Date: Nov. 11, 2004

(54) System and method for distribution channel retailing of charter aircraft services

(76) Inventors: Douglas E. Rank, Seattle, WA (US); Philip N. Graham, Portland, OR (US)

Correspondence Address: KIRKPATRICK & LOCKHART LLP, 75 STATE STREET, BOSTON, MA, 02109-1808, US

(21) Appl. No.: 10/429,532

(22) Filed: May 5, 2003

(51) Int. Cl. G06F 17/21

(52) U.S. Cl. 715/500

(57) ABSTRACT

A system for identifying a charter aircraft including a distribution channel in a supply chain for travel services and an aircraft identification engine in communication with the distribution channel for identifying the charter aircraft based on a plurality of constraints. An embodiment also relates to a method for offering a charter aircraft to a buyer through a third party member of a supply chain, including connecting an aircraft identification engine to the supply chain, wherein the aircraft identification engine is capable of identifying the charter aircraft based on a plurality of constraints.

### BACKGROUND

A charter aircraft generally refers to a private aircraft that, unlike commercial aircraft, fly on-demand customized trips based on specific needs and requirements. Despite the flexibility and other advantages of flying charter, the process of identifying and selecting a suitable aircraft can be considerably more complex than choosing a commercial aircraft.

### SUMMARY OF THE INVENTION

An embodiment of the present invention relates to a system for identifying a charter aircraft. The system includes a distribution channel in a supply chain for travel services and an aircraft identification engine in communication with the distribution channel for identifying the charter aircraft based on a plurality of constraints. Another embodiment of the present invention also relates to a method for offering a charter aircraft to a buyer through a third party member of a supply chain, including connecting an aircraft identification engine to the supply chain, wherein the aircraft identification engine is capable of identifying the charter aircraft based on a plurality of constraints.

### DESCRIPTION OF THE FIGURES

For the present invention to be understood clearly and readily practiced, the present invention will be described in conjunction with the following figures, wherein:

FIG. 1 is an exemplary system that provides a suitable operating environment for an embodiment of the present invention;

FIG. 2 is a schematic diagram of a system that uses a “back-end” architecture for identifying a charter aircraft that satisfies certain constraints according to an embodiment of the present invention;

FIG. 3 is a schematic diagram of a system that uses a “front-end” architecture for identifying a charter aircraft that satisfies certain constraints according to an embodiment of the present invention;

FIG. 4 is a process diagram that illustrates an exemplary method for configuring a distribution channel according to an embodiment of the present invention;

FIG. 5 is a process diagram that illustrates an exemplary method for offering a charter aircraft to a buyer through a third party member of a supply chain according to an embodiment of the present invention;

FIG. 6 is an exemplary summary of certain search results generated according to an embodiment of the present invention;

FIG. 7 is an exemplary summary of certain detailed search results according to an embodiment of the present invention;

FIG. 8 is an exemplary confirmation prepared according to an embodiment of the present invention; and

FIG. 9 and FIG. 10 are process diagrams that illustrate an exemplary method for identifying a charter aircraft based on a plurality of constraints according to an embodiment of the present invention.

### DETAILED DESCRIPTION OF THE INVENTION

An embodiment of the present invention relates to a system for identifying a charter aircraft that includes a distribution channel in a supply chain for travel services and an aircraft identification engine in communication with the distribution channel for identifying the charter aircraft based on a plurality of constraints. Another embodiment of the present invention relates to a method for offering a charter aircraft to a buyer through a third party member of a supply chain, including connecting an aircraft identification engine to the supply chain, wherein the aircraft identification engine is capable of identifying the charter aircraft based on a plurality of constraints. Accordingly, the present invention may be used to provide travel services from a variety of charter aircraft operators through a third party member of a supply chain, such as a distribution channel.

In the following discussion of an illustrative embodiment, “supply chain” refers to all of the resources required for moving products or services through a network of processes, from its sourcing to its delivery to the end consumer. The term “business data,” as used herein, broadly refers to data about people, places, things, and events that are used to operate a business including, but not limited to, pricing, performance, and availability data relating to a charter aircraft. The terms “user,” “buyer,” and “customer” are used interchangeably to refer to a person or entity using the system or method of the present invention. The term “quote,” as used herein, may include, for example, a flight time and a total fee for all segments in a given travel itinerary. The total fee may include, for example, overnight fees, fuel surcharges, landing fees, and crew charges. The term “match,” as used herein, refers to a condition in which two items are of the same measure, quantity, amount, or number as another item or other items or within some predetermined tolerance.

It is to be understood that the figures and descriptions of the present invention have been simplified to illustrate elements that are relevant for a clear understanding of the present invention while eliminating, for purposes of clarity, other elements. For example, certain details relating to the operation and design of a network capable of carrying hypertext traffic, such as the Internet, the specifications of hypertext protocols, such as Hypertext Traveler Protocol (HTP), for use in transporting Hypertext Markup Language (HTML) pages and certain details of suitable storage media or database file formats are not described herein. Those of ordinary skill in the art will recognize, however, that these and other elements may be desirable in an interactive networked environment. A discussion of such elements is not provided because such elements are well known in the art and because they do not facilitate a better understanding of the present invention.

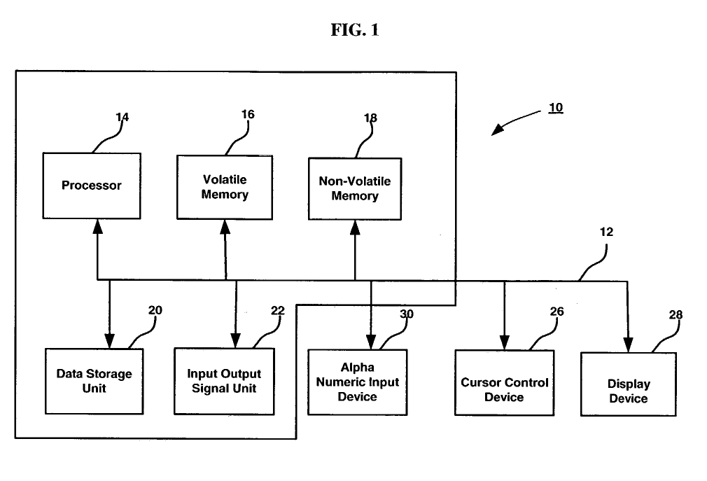

FIG. 1 is a block diagram that illustrates various hardware components of an information processing system 10 used as a part of a communications network in accordance with an embodiment of the present invention. System 10 includes a system bus 12 for conveying information between the various components, a processor 14 for processing the information and instructions, a memory 16 comprised of volatile random access memory (RAM), and a non-volatile read only memory (ROM) 18. System 10 can optionally include, for example, a data storage unit 20 (e.g., a magnetic, optical, floppy, or tape drive) for storing vast amounts of data, and an input/output interface or signal unit 22 for interfacing with peripheral devices (e.g., a computer network, a modem, mass storage devices, etc.). Devices that may be coupled to computer system 10 include, for example, a display device 28 for displaying information to a computer user, an alphanumeric input device 30 (e.g., a keyboard), and a cursor control device 26 (e.g., mouse, trackball, light pen, etc.) for inputting data, selections, updates, etc. In that regard, information processing systemlo may be any network-enabled device such as, for example, a personal computer, a personal digital assistant (PDA), a workstation, a laptop computer, a handheld computing device, or combination thereof.

These are representative components of an information processing system whose operation is well understood. Furthermore, those of ordinary skill in the art will appreciate that system 10 of FIG. 1 is exemplary only and that the present invention can operate within a number of different computer systems including general-purpose computer systems, embedded computer systems, and stand-alone computer systems specially adapted for applications relating to travel services or, more particularly, charter aircraft.

System 10 may also include a computer readable medium having executable instructions or data fields stored thereon, such as storage unit 20. The computer readable medium can be any available medium that can be accessed by a general purpose or special purpose computer. By way of example, and not limitation, such a computer readable medium can comprise RAM, ROM, electrically erasable programmable read only memory (EEPROM), CD-ROM or other optical disk storage, magnetic disk storage or other magnetic storage devices, or any other medium that can be used to store desired executable instructions or data fields and that can be accessed by a general purpose or a special purpose computer.

The computer readable medium tangibly embodies a program, functions, and/or instructions that cause the computer system to operate in a specific and predefined manner as described herein. Those skilled in the art will appreciate, however, that the process described below may be implemented at any level, ranging from hardware to application software and in any appropriate physical location. For example, the present invention may be implemented as software code to be executed by system 10 using any suitable computer language and may be stored on any of the storage media described above, or can be configured into the logic of system 10. Such software code may be executed by system 10 using any suitable computer language such as, for example, Java, Javascript, C++, C, C#, Perl, Visual Basic, Transact/Structure Query Language (T/SQL), database languages, APIs, various system-level SDKs, assembly, firmware, microcode, and/or other languages and tools.

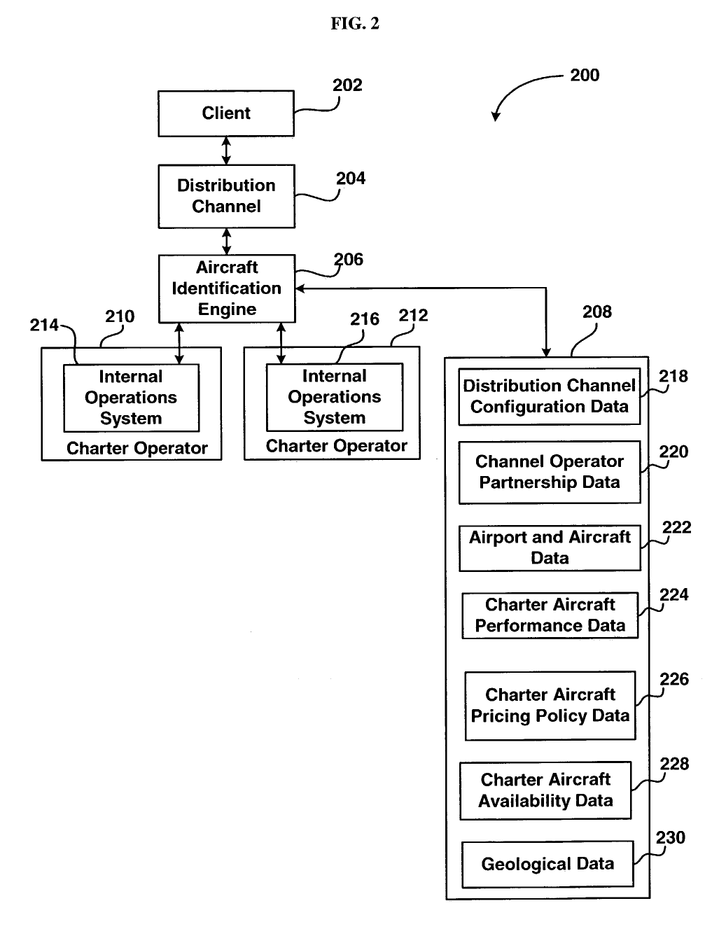

FIG. 2 is a schematic diagram of a system 200 for identifying a charter aircraft based on a plurality of constraints according to an embodiment of the present invention. System 200 may include a client 202, a distribution channel 204, an aircraft identification engine 206, a database 208, and participating charter operators 210 and 212 having various internal fleet management or operations systems 214 and 216. Client 202 may be coupled to distribution channel 204 which, in turn, may be coupled to aircraft identification engine 206, forming a so-called “backend architecture.” As shown in the illustrated embodiment, operations systems 214 and 216 may be coupled to aircraft identification engine 206. Aircraft identification engine 206 may also be coupled to database 208. Information processing system 10 shown in FIG. 1 is representative hardware of client 202, aircraft identification engine 206, distribution channel 204, and operations systems 214 and 216.

In the illustrated embodiment, communication may be over any suitable computer network including, for example, metropolitan area networks (MAN) and/or various “Internet” or IP networks such as the World Wide Web, a private Internet, a secure Internet, a value-added network, a virtual private network, an extranet, or an intranet. Other suitable networks may contain other combinations of servers, clients, and/or peer-to-peer nodes. The invention may also be practiced in distributed computing environments where tasks are performed by remote processing devices that are linked through a communications network. In a distributed computing environment, program modules may be located in both local and remote memory storage devices.

Communication may be by exchanging data packets according to a predefined set of protocols, such as the Transmission Control Protocol/Internet Protocol (TCP/IP). Those of ordinary skill will appreciate that other techniques or protocols, such as HTTP, may be suitable for use with the present invention. According to an embodiment, HTTP or any of several other standard protocols may be used to exchange information, which could then be formatted for display.

According to an embodiment, an XML schema may be used exchange information. Information exchanged in XML form may include information associated with a request for travel services including, for example, rules associated with a travel itinerary or a unique identifier associated with distribution channel 204. Thus, according to another embodiment, distribution channel 204 may interact with the user via a web interface, and communicate the user's search request to aircraft identification engine 206 via XML and receives and processes the XML-formatted response. For example, client 202 may include an interactive application that receives certain constraints and communicates an XML-formatted search description to aircraft identification engine 206. System 200 may also receive response messages and format the search results for presentation on client 202. Those of ordinary skill in the art will appreciate that the search results for the charter aircraft may be shown among other search results based on more general requests for travel services.

According to another embodiment, information may be exchanged using HTML forms. Those of ordinary skill in the art will appreciate that many of the same tasks described above in connection with XML may also be accomplished with HMTL forms.

Distribution channel 204 may be a third party member of a supply chain that acts as information intermediary, and may focus a certain industry. For example, distribution channel 204 may be a web-based entry point, such as a web portal, that offers a broad array of resources and services to execute all transactions associated with a particular theme. Distribution channel 204 may be implemented using, for example, Sabre Travel Network™ available from Sabre Holdings Corporation of Southlake, Tex. Although FIG. 2 illustrates only one distribution channel, those of ordinary skill in the art will understand that system 200 may include more than one distribution channel.

Client 202 allows charter customers to invoke aircraft identification engine 206 to identify a charter flight available through charter operators 210 and 212. System 200 may be configured to allow charter customers to search for, for example, pricing or charter flight reservation information though distribution channel 204. Client 202 may use a web browser to gain access to web site 204 and to navigate, view or retrieve services stored on distribution channel 204, aircraft identification engine 206, internal operations systems 214 and 216, or database 208, or any combination thereof. The pages may be hypertext documents created using a conventional HTML format. Although FIG. 2 illustrates only one client, those of ordinary skill in the art will understand that system 200 may include more than one client.

Aircraft identification engine 206 may be configured to identify charter flights according to an embodiment of the present invention. Engine 206 may be used to indicate, for example, when charter aircraft operators are available to fly charter flights, how the aircraft are priced, which network members they wish to do business with, and how the aircraft should be branded and presented. Engine 206 may also be configured to manage air charter flights operated by any number of participating charter operators. Aircraft identification engine 206 may be implemented using, for example, the CharterXtra system available from Boston Aviation Services of Cambridge, Mass.

Database 208 may be any body of information that is logically organized so that it can be retrieved, stored and searched in a coherent manner by a “database engine”—i.e., a collection of methods for retrieving or manipulating data in the database. Database 208 may include several pools of data including, for example, distribution channel configuration data 218, channel-operator partnership data 220, airport and aircraft data 222, charter aircraft performance data 224, charter aircraft pricing policy data 226, charter aircraft availability data 228, and geological data 230. These pools of data may be incorporated into aircraft identification engine 206 or may be dispersed throughout system 200.

Distribution channel configuration data 218 may include configuration options associated with distribution channel 204 that may specify, for example, certain search types a user may run through distribution channel 204. Search types may relate to, for example, a maximum number of charter candidates in the results, a plurality of sort criteria, or an aircraft category. Aircraft identification engine 206 may also include, for example, web pages to facilitate input of distribution channel configuration data 218.

Channel-operator partnership data 220 may include information that correlates, for example, charter operator 210 with distribution channel 204 or any other distribution channel through which charter operator 210 offers its services. For example, channel-operator partnership data 220 may correlate distribution channel 204 with charter operators 210 and 212 or any other charter operators that offer charter services through distribution channel 204. Aircraft identification engine 206 may also include, for example, web pages to facilitate input of channel-operator partnership data 220.

Airport and aircraft data 222 may include airport specific information such as its location, its runway capabilities and requirements, or the types of aircraft it can accommodate. The airport specific information may be obtained from, for example, the Jeppesen Electronic Airport Directory available from Jeppesen of Wilsonville, Oreg. or from wwwjeppsen.com. Information concerning the types of aircrafts may be obtained from, for example, The Aircraft Comparator available from from Conklin & de Decker of Orleans, Mass. or at http://www.conklindd.com.

Charter aircraft performance data 224 may include performance data for a specific aircraft including, for example, its cruise speed, range, required runway length or speed/range breakpoints. Performance data may be determined by way of an optimization process by which performance associated with system 200 is matched to, for example, the calculations of charter operator 210. The optimization process may be implemented using, for example, CharterX available from Boston Aviation Services, Inc. of Cambridge, Mass.

Charter aircraft pricing policy data 226 may include information about pricing rules applicable to a specific charter aircraft. For example, charter aircraft pricing policy data 226 may include a base hourly rate for the aircraft, charges for landing fees, overnight stays and crew wait time, as well as custom charges determined by, for example, charter operator 210. According to an embodiment, aircraft identification engine 206 may include web pages to facilitate input of charter aircraft pricing policy data 226.

Charter aircraft availability data 228 may include information that describes an airport at which a certain charter aircraft is based or an airport at which it may be located between specific times. Charter aircraft availability data 228 may also include certain times during which the aircraft is unavailable. According to an embodiment, aircraft identification engine 206 may include web pages to facilitate to input or update charter aircraft availability data 228. According to another embodiment, charter aircraft availability data 228 may be input or updated via desktop fleet management applications, such as operations systems 214 and 216.

Geological data 230 may include information describing whether a given point on the earth's surface is land or sea. Geological data 230 may also describe seasonal winds at varying altitudes above certain points on the earth's surface. Geological data 230 may be implemented using, for example, data sets available from the National Center for Atmospheric Research of Boulder, Colo. or at http://dss.ucar.edu.

Charter fleet management systems 214 and 216 may be any internally operated flight information management and support system, respectively operated by charter operators 210 and 212, that manages such tasks as, for example, airport locating, route planning, passenger and pilot scheduling, charter cost estimation, bidding and invoicing. Charter fleet management systems 214 and 216 may be implemented using, for example, FOS/NT™ available from Computer Technologies for Aviation, Inc. of Charlottesville, Va. or NavPak available from San Francisco Marketing Group, Inc. of Sausalito, Calif. Fleet management systems 214 and 216 may use the same or different algorithms to calculate, among other things, flight time. According to other embodiments, charter fleet management systems 214 and 216 may include manual operations.

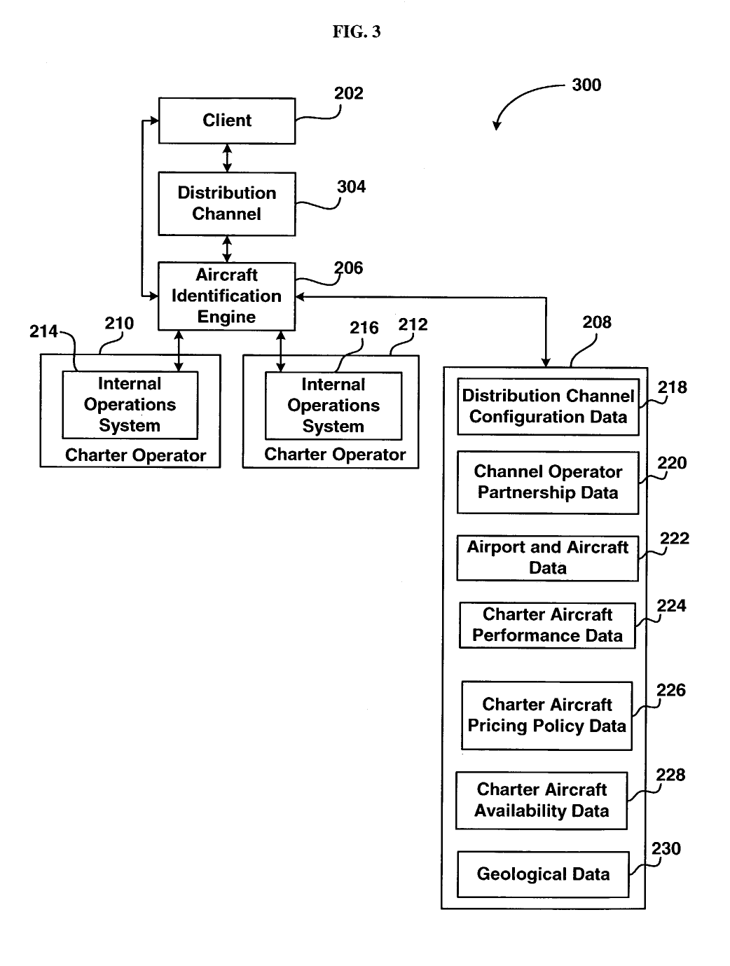

FIG. 3 is a schematic diagram of a system 300 that uses a so-called “front-end” architecture for identifying a charter aircraft that satisfies certain constraints according to an embodiment of the present invention. System 300 is similar in many respects to system 200 shown in FIG. 2 except that system 300 provides for direct communication between client 202 and aircraft identification engine 206. In this way, aircraft identification engine 206 may be viewed as an application service provider (ASP). According to such an embodiment, distribution channel 304 may include an HTML form on a web page controlled and served by distribution channel 304 but configured to submit the web page contents directly to aircraft identification engine 206 following an initial request that identifies distribution channel 304, such as by including a unique identifier in the request. Thus, aircraft identification engine 206 may impersonate the look-and-feel of distribution channel 304.

FIGS. 1 through 3 and the foregoing discussion are intended to provide a brief, general description of a suitable computing environment in which the invention may be implemented. Although not required, the invention is described herein in the general context of computer-executable instructions, such as program modules, being executed by a computer. Thus, the hardware and software configurations depicted in FIGS. 1 through 3 are intended merely to show a representative configuration. Accordingly, it should be understood that the invention encompasses other computer system hardware configurations and is not limited to the specific hardware and software configurations described above.

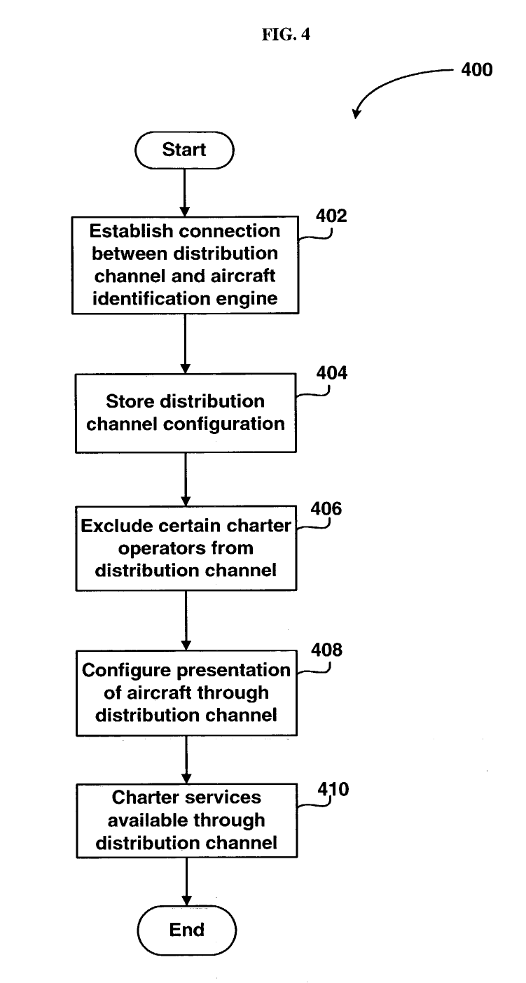

FIG. 4 is a process diagram that illustrates an exemplary method 400 for configuring distribution channel 304 according to an embodiment of the present invention. Method 400 begins in step 402 when a distribution channel, such as distribution channel 304, is operatively coupled to aircraft identification engine 206, which may be preceded by an agreement between the operators of distribution channel 304 and the operators of aircraft identification engine 206.

In step 404, system 300 may save preferences or settings associated with distribution channel 304, such as in distribution channel configuration data 218, to customize results and displays. According to an embodiment, system 300 may assign distribution channel 206.

In step 406, according to an embodiment, distribution channel 304 may selectively identify the charter operators for which it will facilitate charter aircraft requests. For example, distribution channel 304 can choose to represent all operators; all operators except certain ones they exclude; or choose only certain operators whose aircraft will be presented. Those of ordinary skill in the art will appreciate that this architecture would allow distribution channel 304, for example, to exclude certain charter operators for poor service or to accommodate specialty channels that represent a specific subset of operators (e.g. a trade association of charter helicopter operators).

In step 408, according to an embodiment, charter operator 210 may selectively identify a distribution channel, such as distribution channel 304, through which to present its aircraft. According to such an embodiment, system 300 may also allow charter operators, such as charter operator 210, to customize the presentation of aircraft through distribution channel 304. For example, an aircraft scheduled to fly empty on a given route may or may not be presented through distribution channel 304. As another example, charter operator 210 could establish pricing rules that relate to certain distribution channels, such as distribution channel 304. According to another embodiment, distribution channel 304 may perform many of the same operations describe above in connection with charter operator 210. The process concludes in step 410 when charter services, such as those offered by charter operator 410, are available through distribution channel 304.

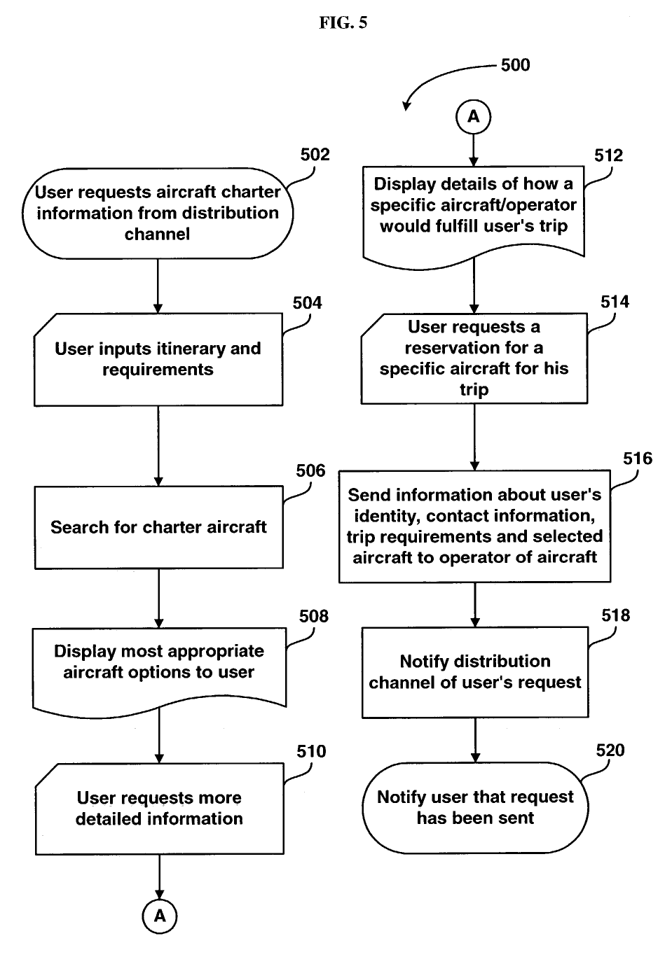

FIG. 5 is a process diagram that illustrates an exemplary method 500 for offering a charter aircraft to a buyer through a third party member of a supply chain according to an embodiment of the present invention. Method 500, which may follow the configuration process described in connection with FIG. 4, begins in step 502 when aircraft identification engine 206 receives a request for information about travel services from client 202 through distribution channel 304. Distribution channel 304 may respond by transmitting an interactive form with which the user can input specific travel requirements (also referred to as “rules”), including an itinerary.

In step 504, the user, interacting with distribution channel 304, may transmit, for example, desired travel dates, general locations of travel, number of passengers, specific airports to use, general or specific types of aircraft, maximum number of stops between departure and arrival in a given leg, or a repositioning parameter that indicates the maximum time or distance a charter aircraft should travel to position itself at the beginning of the itinerary. According to an embodiment, system 300 may include default values or responses for some or all of the information input in step 504.

In step 506, aircraft identification engine 206 invokes a method 600 to identify candidate charter aircraft that satisfy certain rules, such as the itinerary (hereafter referred to as “search results”). According to an embodiment, aircraft identification engine 206 may search among those aircraft whose operators have agreed to present their aircraft to distribution channel 304 and those operators who distribution channel 304 has chosen to present. According to an embodiment, system 300 may sort the search results according to certain criteria.

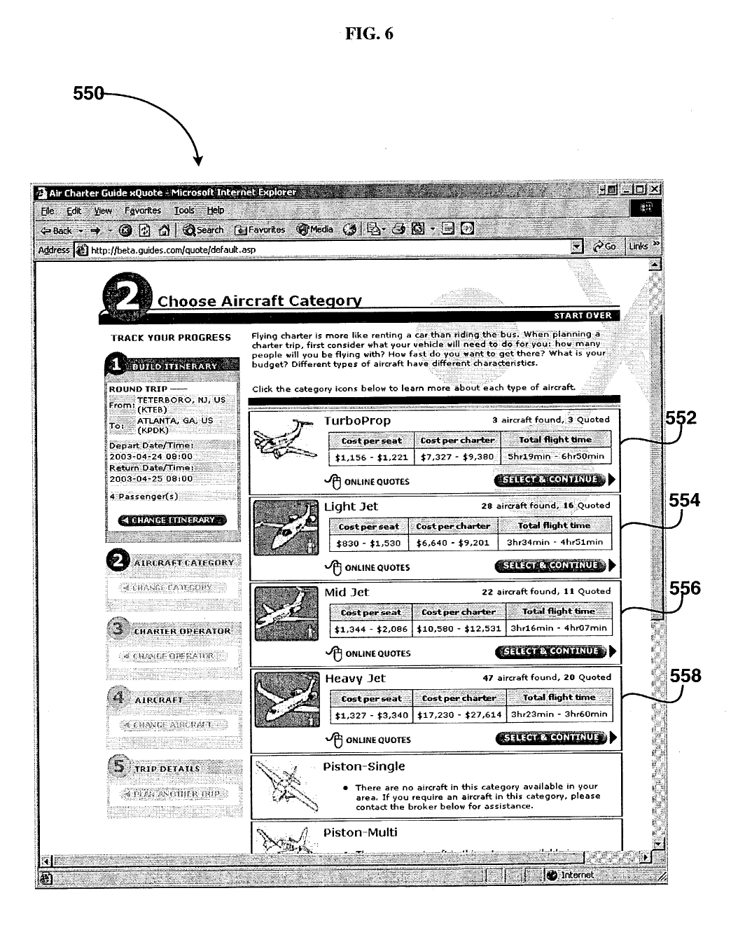

In step 508, aircraft identification engine 206 may display various summaries of the search results based on, for example, configuration commands input by the operators of distribution channel 304 or by users of system 300. FIG. 6 is an exemplary summary 550 of the search results obtained in step 508 according to an embodiment of the present invention. For example, summary 550 presents the aircraft found in general categories of aircraft type including a turboprop 552, a light jet 554, a midsize jet 556, or a heavyjet 558. According to an embodiment, method 500 may omit step 508 and go directly from step 506 to step 510. In step 510, the user may request additional details on, for example, the search results for light jet 554 (hereafter referred to as “detailed search results”).

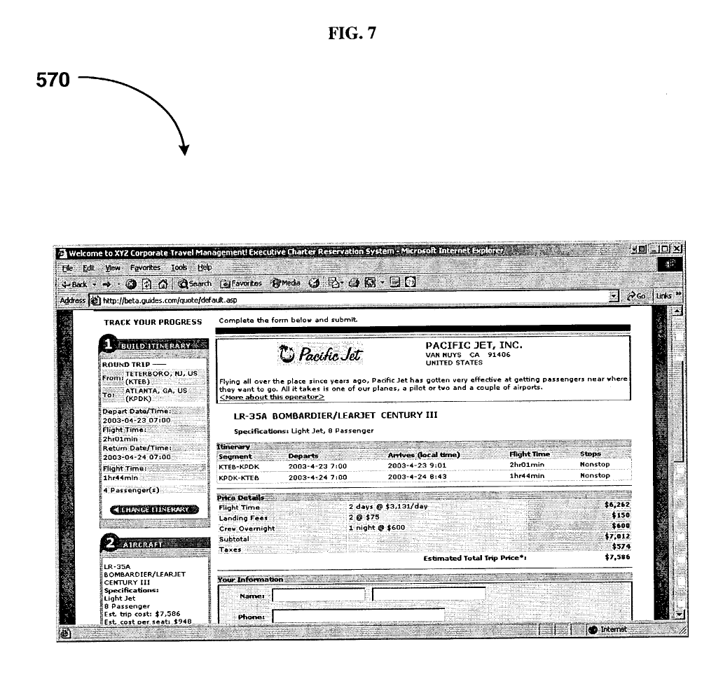

In step 512, system 300 displays the detailed search results, such as for light jet 554, which may be may limited, formatted, and organized according to distribution channel configuration data 218. FIG. 7 is an exemplary summary 570 of the detailed search results for light jet 554 according to an embodiment of the present invention. According to an embodiment, system 300 may be configured to hide (or not to hide) the name of the charter operator in the search results or detailed search results. For example, if aircraft identification engine 206 communicates directly with client 202, system 300 may not display the name of charter operator 210 on client 202. Alternatively, system 300 may display the name of charter operator 210 on client 202, in which case distribution channel 304 acts as an agent of charter operator 210.

In step 514, the user requests a reservation for a specific aircraft, such as light jet 554, among the detailed search results displayed in step 512. In step 516, the request is submitted, for example, to charter operator 210 via aircraft identification engine 306. According to an embodiment, the request may include, for example, user-specified information associated with the request, the user's contact information, or other questions directed to charter operator 210.

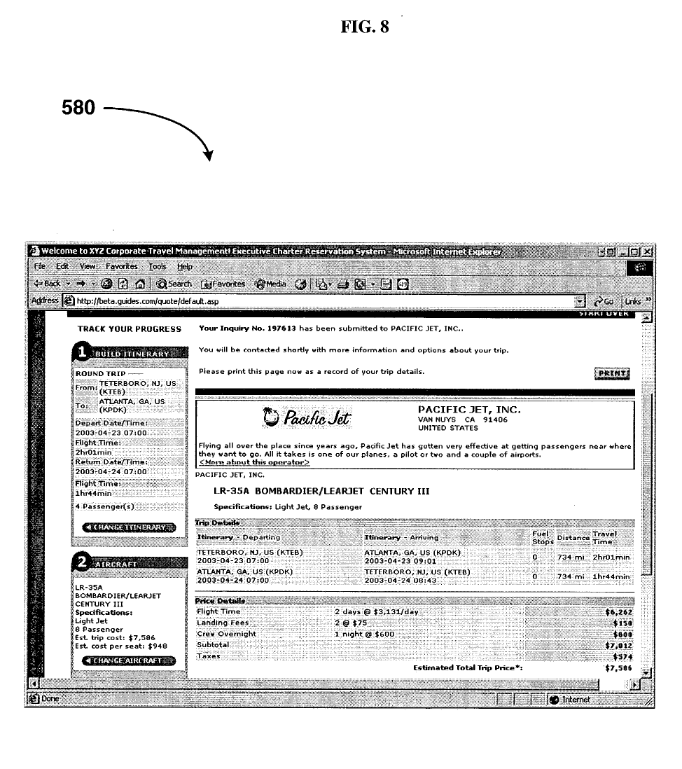

In step 518, system 300 informs distribution channel 304 of the request. In step 520, system 300 issues a confirmation to the user that confirms the request has been sent to charter operator 210. FIG. 8 illustrates an exemplary confirmation 580 sent to client 202 in connection with step 520 according to an embodiment of the present invention.

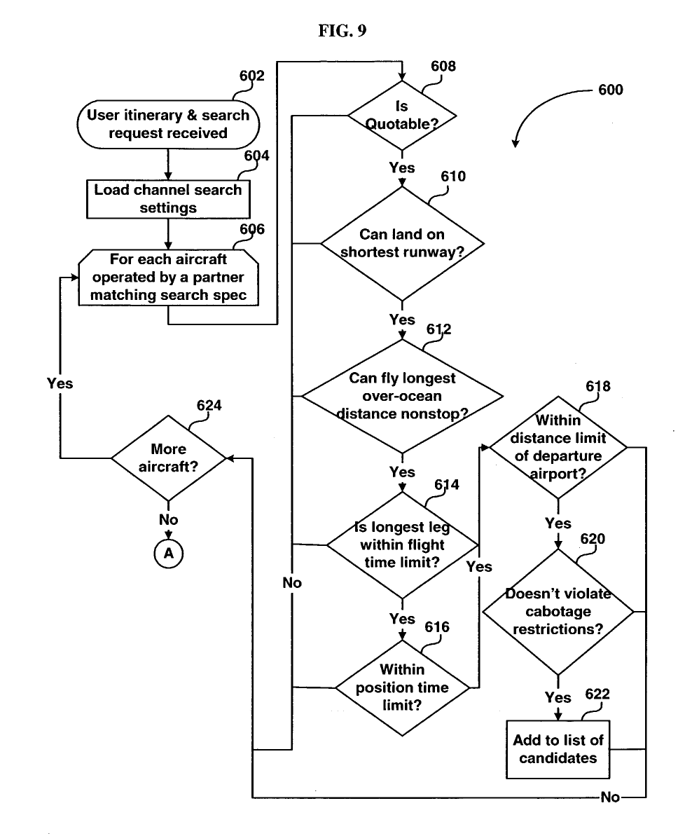

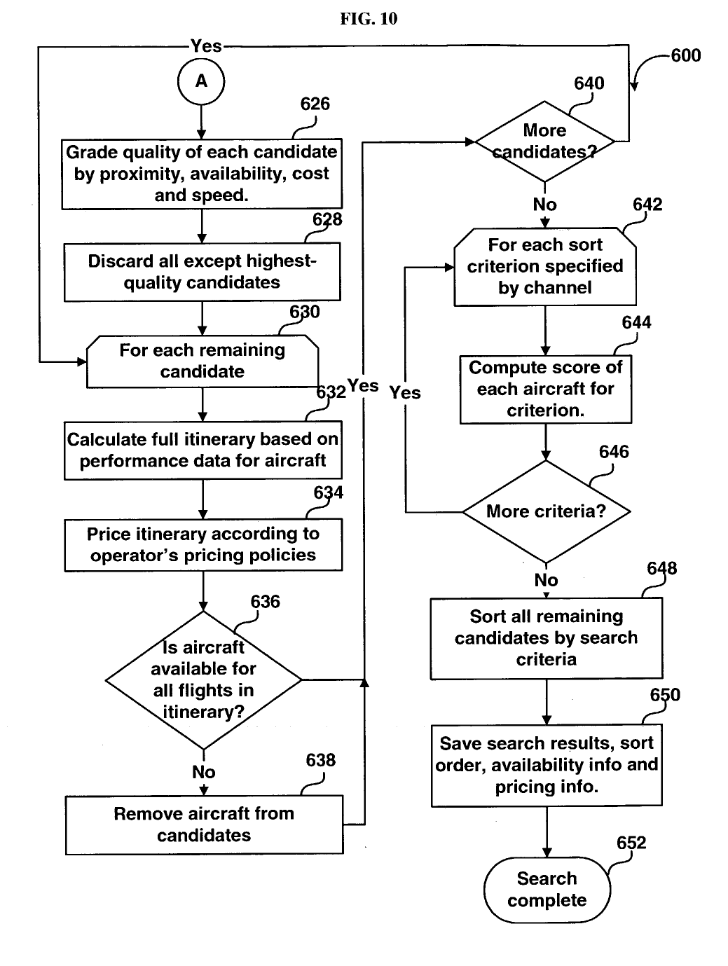

FIG. 9 and FIG. 10 illustrate exemplary method 600 for identifying a charter aircraft based on a plurality of constraints according to an embodiment of the present invention. Method 600 begins in step 602 when aircraft identification engine 206 receives the request and thereafter, in step 604, loads distribution channel configuration data 218. In step 606, aircraft identification engine 206 uses channel-operator partnership data 220 to assemble a list of available charter aircraft that also match the rules associated with the request. For example, if the user has specified 10 passengers, the aircraft must carry at least 10 passengers. If the user has requested a light jet, the aircraft must be a light jet, etc.

In step 608, for each aircraft identified in step 606, aircraft identification engine 206 uses charter aircraft pricing policy data 226 and charter aircraft performance data 224 to determine whether the aircraft is quotable. To be quotable, the charter operator, such as charter operator 210, must have defined a pricing policy for the aircraft and the aircraft must be optimized so that a flight time, as presented through distribution channel 304, matches or nearly matches, a corresponding flight time determined by internal operations system 214.

In step 610, aircraft identification engine 206 verifies that the aircraft is operationally capable of fulfilling the request. For example, in step 610, method 600 may verify that the aircraft can land on the shortest runway in the itinerary using airport and aircraft data 222. In step 612, if the user's itinerary includes segments that cross an ocean, aircraft identification engine 206 uses geological data 230 to determine whether the aircraft can fly the longest over-ocean segment non-stop.

In step 614, if distribution channel configuration data 218 specifies a maximum flight time for the aircraft's category, aircraft identification engine 206 uses charter aircraft performance data 224 to verify that the aircraft can fly the longest itinerary segment in less than that time. In step 616, if the request specifies a maximum position time, which refers to the time an aircraft must fly from its current location to the user's departure airport, aircraft identification engine 206 uses the charter aircraft availability data 228 and charter aircraft performance data 224 to verify that the aircraft can position in less than the maximum position time. In step 618, if the request specifies a maximum radius from the departure airport, aircraft identification engine 206 uses charter aircraft availability data 228 to verify that the aircraft is currently located within this radius.

In step 620, if all of the airports in the itinerary are within the same country, aircraft identification engine 206 verifies that the aircraft does not violate cabotage regulations.

If the aircraft satisfies all of the conditions described in steps 608 through 620, aircraft identification engine 206 adds the aircraft to a list of candidate aircraft in step 622 before selecting the next aircraft in step 624.

In step 626, aircraft identification engine 206 computes the quality of each candidate aircraft using, for example, a weighted average of scores for proximity to the user's location, availability, range of the aircraft, and speed of the aircraft. In other embodiments, the score may include, for example, the price of the aircraft.

In step 628, aircraft identification engine 206 retains a list of surviving candidates with the highest quality scores. According to an embodiment, system 300 prepares the list of surviving candidates retained in step 628 according to distribution channel configuration data 218, which may designate, for example, the maximum of number of surviving candidates.

In step 630, aircraft identification engine 206 loops through the surviving candidates and, in step 632, prepares a full itinerary for each surviving candidate that satisfies the request. The full itinerary may include, for example, all flight times and operational details necessary to price the request according to the pricing policy, for example, of charter operator 210. Such operational details may include, for example, overnight stops, landings, and crew wait time.

In step 634, aircraft identification engine 206 prices the full itinerary developed in step 630 using charter aircraft pricing policy data 226. According to an embodiment, aircraft identification engine 206 searches charter aircraft pricing policy data 226 for fee items corresponding to those in the full itinerary. For example, if charter aircraft pricing policy data 226 indicates a fee of $500 per landing, and the itinerary shows the aircraft landing four times, system 300 would assess $2000 in landing fees.

In step 636, aircraft identification engine 206 verifies that the aircraft is available for every contiguous block of time in the full itinerary developed in step 630 using charter aircraft availability dataset 228. If the aircraft is not available, aircraft identification engine 206 removes it from the list of candidates in step 638.

In step 640, aircraft identification engine 206 checks for more candidates and, if so, repeats steps 630 through 638.

Otherwise, in step 642, aircraft identification engine 206 loops through each sort criterion specified in distribution channel configuration data 218. According to an embodiment, the sort criteria may include price, aircraft type, or the date of the last availability update.

In step 644, aircraft identification engine 206 computes a score for each surviving candidate. In step 646, if any sort criteria remain, aircraft identification engine 206 repeats steps 642 and 644. In step 648, aircraft identification engine 206 sorts the surviving candidates, for example, by score or other criterion. In step 650, aircraft identification engine 206 saves the surviving candidates, sort order, availability information, and pricing information before concluding method 600 in step 652.

The foregoing description has been limited to a few specific embodiments of the invention. It will be apparent, however, that variations and modifications can be made to the invention, with the attainment of some or all of the advantages of the invention. Therefore, it is the object of the appended claims to cover all such variations and modifications as come within the true spirit and scope of the invention.

What is claimed is:

1. A system for identifying a charter aircraft comprising:
a distribution channel in a supply chain for travel services; and
an aircraft identification engine in communication with the distribution channel for identifying the charter aircraft based on a plurality of constraints.

2. The system of claim 1 further comprising a client in communication with the distribution channel for communicating a request to the distribution channel, wherein the request includes the plurality of constraints.

3. The system of claim 2 wherein the request is communicated via XML.

4. The system of claim 2 wherein the request is communicated using HTML forms.

5. The system of claim 2 wherein the client communicates with the aircraft identification engine.

6. The system of claim 5 wherein the request is communicated via XML.

7. The system of claim 5 wherein the request is communicated using HTML forms.

8. The system of claim 2 wherein the aircraft identification engine identifies the charter aircraft among a plurality of candidate charter aircraft that are substantially capable of satisfying the plurality of constraints.

9. The system of claim 8 wherein the aircraft identification engine ranks the plurality of candidate aircraft based on the plurality of constraints.

10. The system of claim 1 further comprising a charter operator in communication with the aircraft identification engine for providing the charter aircraft.

11. The system of claim 1 further comprising a database in communication with the aircraft identification engine including data relating to the charter aircraft.

12. The system of claim 1 further comprising a database in communication with the aircraft identification engine including aircraft business data.

13. The system of claim 1 further comprising reserving the charter aircraft.

14. The system of claim 1 further comprising quoting the charter aircraft.

15. The system of claim 1 wherein the plurality of constraints includes an itinerary.

16. The system of claim 1 wherein the aircraft identification engine is capable of transmitting a confirmation to the distribution channel.

17. A method for offering a charter aircraft to a buyer through a third party member of a supply chain comprising connecting an aircraft identification engine to the supply chain, the aircraft identification engine being capable of identifying the charter aircraft based on a plurality of constraints.

18. The method of claim 17 further comprising transmitting a result that includes a plurality of candidate charter aircraft that substantially satisfy the plurality of constraints.

19. The method of claim 18 further comprising configuring the distribution channel to customize the result.

20. The method of claim 18 further comprising ranking the plurality of candidate aircraft based on the plurality of constraints.

21. The method of claim 17 wherein identifying the charter aircraft includes quoting the charter aircraft.

22. The method of claim 17 wherein identifying the charter aircraft includes reserving the charter aircraft.

23. The method of claim 22 further comprising transmitting a confirmation to the distribution channel.

24. The method of claim 17 further comprising integrating the plurality of candidate aircraft with other information relating to travel services.

25. A web page generated by a computer, the web page containing data soliciting responses from a user that are provided to a computer having a memory with computer-executable instructions that implement the user responses to cause the computer to perform the steps comprising:
receiving a plurality of constraints through a third party member of a supply chain; and
returning a plurality of candidate charter aircraft that substantially satisfy the plurality of constraints.

26. A network comprising:
a client;
a distribution channel in communication with the client; and
a aircraft identification engine in communication with the distribution channel for identifying the charter aircraft based on a plurality of constraints.
